(19) United States
(12) Patent Application Publication
(10) Pub. No.: US 2015/0182960 A1
(43) Pub. Date: Jul. 2, 2015

(54) ZEOLITE REGENERATION

(71) Applicant: Ecowater Systems LLC, Woodbury, MN (US)

(72) Inventor: George Dimotsis, Woodbury, MN (US)

(21) Appl. No.: 14/577,452

(22) Filed: Dec. 19, 2014

Related U.S. Application Data
(60) Provisional application No. 61/922,407, filed on Dec. 31, 2013.

(51) Int. Cl. B01J 49/00; C02F 1/42

(52) U.S. Cl. CPC B01J 49/0073; C02F 1/42; C02F 2001/422; C02F 2303/16

(57) ABSTRACT

A non-chloride containing, low TDS regenerant composition for regenerating a strong acid cation exchange resin of about 1 to 60 weight percent an inorganic sodium zeolite, and the balance of water. The inorganic sodium zeolite is Type A, P, MAP, or X sodium zeolite, or any combination thereof. At least one surfactant may be added to the composition. A method for treating a spent strong acid cation exchange resin to regenerate the resin utilizes the regenerant composition. The method dilutes a concentrated suspension of at least one inorganic sodium zeolite; and combines the balance of water.

### BACKGROUND OF THE INVENTION

1. Field of the Invention

This invention is directed generally to non-chloride low total dissolved solids (TDS) containing regenerant compositions of sodium form inorganic zeolites as well as methods for efficient regeneration of water softeners utilizing the sodium form zeolites which are disclosed. A preferred regenerant composition is an aqueous suspension of a sodium form zeolite Type A, P, MAP, or X, which may be combined with a surfactant, such as an ethoxylated fatty acid.

2. Description of Related Art

Hard water contains certain minerals, such as calcium and magnesium which can be detrimental to a water system. Specifically these minerals will form an undesirable precipitate when they come in contact with soap, and will form scale in piping, water heaters, pots, and washing machines. To alleviate this problem, water softening systems have become quite popular. Such systems convert hard water to soft water by removing minerals (mainly magnesium and calcium) from hard water. This is done by a process known as cation exchange. In this process, sodium or other cations are substituted for calcium and magnesium ions in the hard water. This contributes to the TDS of the effluent waste water, as well as the alkali chlorides. The high TDS effluent is then sent through a drain to the sewer system as any drain water from a house

Thus, there remains a need for an alternative method which allows efficient regeneration without release of chloride or high TDS by-products to a sewer system.

### SUMMARY OF THE INVENTION

It is an object of this invention to provide a composition and a method for regenerating water softeners without releasing chlorides or high TDS solutions.

It is a further object of this invention to provide an efficient method which allows accurate metering of the necessary amount of regenerating agent for most efficient regeneration of water softeners.

The above and other objects, which will be apparent to those skilled in the art, are achieved in the present invention which is directed to a non-chloride containing, low TDS regenerant composition for regenerating a strong acid cation exchange resin comprising about 1 to 60 weight percent an inorganic sodium zeolite, and the balance of water. The inorganic sodium zeolite may comprise Type A, P, MAP, or X sodium zeolite, or any combination thereof, and may include about 0.0005 to 0.5 weight percent of at least one surfactant.

The at least one surfactant is preferably anionic or non-ionic.

The inorganic sodium zeolite may comprise a fine solid powder or pre-made stable aqueous suspension.

The regenerant composition may further include additives to provide protection against development of fouling problems, the additives including citric acid to sequester iron present in the hard water that potentially fouls the cation exchange resin sites; or reducing agents; or a combination thereof.

The reducing agents are preferably non-toxic, and include erythorbic acid, ascorbic acid, or water soluble salts thereof.

In a second aspect, the present invention is directed to a method for treating a spent strong acid cation exchange resin to regenerate the resin comprising the steps of: diluting a concentrated suspension of at least one inorganic sodium zeolite; and combining the balance of water.

The method may include combining at least one surfactant to form a dilute solution from about 5 to about 60 weight % inorganic sodium zeolite.

### DESCRIPTION OF THE PREFERRED EMBODIMENT(S)

The cation exchange process basically involves running hard water through an exchange media, such as an organic resin bed or zeolite softener regenerated with exchangeable cations, such as sodium ions or potassium ions. These ions are attached to the resin beads due to an inherent negative charge in the beads. A brine solution, consisting of sodium chloride or potassium chloride dissolved in water, is run over the beads for regeneration. Once the beads are regenerated, the system is ready to operate by running hard water through the beads. Cation exchange then takes place, and the resultant effluent water is soft.

Eventually, the sodium or potassium ions carried by the beads will be depleted, or virtually depleted. The beads will then need to be regenerated with sodium or potassium. The regeneration process is the same as the initial regeneration; effluent brine will contain magnesium, calcium, and sodium chloride or potassium chloride.

The effluent liquid from the regeneration process will have a relatively high concentration of NaCl or KCl, as high as 5-10%. Other elements, such as manganese, iron, sodium, magnesium, and potassium, either naturally existing in the water or collected as a result of water softening, contribute to the TDS of the effluent waste water, as well as the alkali chlorides.

The high TDS effluent is then sent through a drain to the sewer system as any drain water from a house. Due to recent environmental concerns and the desire for water reclamation, many municipalities are enacting or considering ordinances limiting the amount of chlorides and/or TDS that can be sent through sewer systems. These limits often are on the order of 250 ppm chlorides and 500 ppm TDS. Since effluent in the regeneration process far exceeds these maximum acceptable amounts, water softeners have been banned by some municipalities.

To meet the new stricter requirements, the residential softener can be regularly changed out to remove the undesirable products without flushing them into the sewer system. Such change outs typically involve service personnel periodically traveling to the houses or offices having water softeners, removing the tanks with the exhausted beads and exchanging them for tanks with recharged beads. The exhausted tanks are taken to a facility for a centralized regeneration process. Once regenerated, these tanks can again be used to replace tanks with exhausted beads.

The invention is directed to a non-chloride containing, low TDS regenerant composition for regenerating a strong acid cation exchange resin comprising: from about 1 to 60 weight percent of at least one of an inorganic sodium zeolite selected from a Type A, P, MAP or X sodium zeolite, and optionally from about 0.0005 to 0.5 weight percent of at least one surfactant, with the remaining balance of water.

Zeolites have a porous structure that can accommodate a wide variety of cations, such as Na⁺, K⁺, Ca²⁺, Mg²⁺ and others. These positive ions are rather loosely held and can readily be exchanged for others in a contact solution.

The invention is also directed to methods for treating a spent strong acid cation exchange resin to regenerate the resin which include the steps of: diluting a concentrated suspension of at least one inorganic sodium zeolite selected from Zeolite A, Zeolite P, Zeolite X or a blend of two or more, and optionally adding at least one surfactant to form a dilute solution from about 5 to about 60 weight % inorganic sodium zeolite Type A, P, MAP, or X; as well as optionally adding about 0.0005 to 0.5 weight percent of at least one surfactant, such as Polysorbate 80; with the remaining balance of water, and passing the solution through a bed of the resin or blending the solution with a bed of the resin and allowing the bed time to equilibrate.

For the practice of any aspect of this invention, the inorganic sodium zeolite may be maximum aluminum zeolite NaP (also known as MAP or Zeolite MAP) and the amount of Zeolite MAP may be from about 5 to 50 weight percent, and more preferably from about 10 to 40 weight percent. A presently preferred surfactant is Polysorbate 80.

NaCl is conventionally used as a regenerant for residential water softeners. KCl has been disclosed as a regenerant in U.S. Pat. Nos. 4,116,860 and 4,071,446. Alkali metal acetates were disclosed as regenerants, and also as poor regenerants of weak cationic exchange resins in U.S. Pat. No. 5,665,783. Potassium salts as regenerants were disclosed in U.S. Pat. No. 6,340,712.

Traditionally, regenerants for residential water softeners are purchased in bulk (40 or 50 pound bags) as solid granules. Periodically, the owner/operator of the softener adds these granules to water in the brine tank of the softener in sufficient quantity to form a saturated brine solution. This solution, in turn, is diluted to the desired concentration in the softener prior to flowing through the bed of cation exchange resin at the time of regeneration.

In the present invention, a suspension of either Zeolite A, P, MAP, X or a suspension of mixtures of two or more of either Zeolite A, P, MAP, X is utilized to regenerate the strongly acidic cation resin. Although currently existing softening equipment must be modified to accommodate proper generation of suspended regenerants, the basic regeneration process can remain unchanged with regeneration occurring by passing the regenerating suspension through the bed of cation exchange resin. Alternatively, the regenerating suspension can be blended with the cation exchange resin, allowed to equilibrate and be subsequently rinsed away.

### The Surfactant

The surfactant is preferably anionic or non-ionic as cationic surfactants will bind to the resin exchange sites. The candidate surfactants must be safe for human consumption at low levels in drinking water, as minute quantities of the regenerating composition might be carried into the treated water supply. The surfactant should be low foaming at the normal level of use to prevent the introduction of air into the softener. The surfactant should be soluble in the regenerating suspension and compatible with hard water so no insoluble precipitates are formed.

### The Method

All current regenerations on residential softener resins ultimately utilize liquid regenerants containing soluble salts. Unlike conventional soluble salt regenerants, the Zeolites would be used as either fine solid powders or pre-made stable aqueous suspensions. Although existing softeners will require minor modifications to accommodate production of or use of stable aqueous suspensions of solid regenerants, the regeneration process within the softener can be entirely analogous to conventional operation. The amount of regenerant used will depend on the level of hardness in the water to be treated, the usage of the softened water, and the desired interval between regenerations. These are the same parameters and dependence factors associated with conventional regenerants. Service cycles following regeneration with Zeolites are comparable in length or longer than those obtained with liquid solutions of soluble salts. Other constituents could be added to the stabile suspensions as long as they do not interact to destabilize the suspensions.

The regenerant composition may also contain other additives to provide protection against development of fouling problems, preferably citric acid to sequester iron present in the hard water that potentially fouls the cation exchange resin sites. Reducing agents may also be present, the reducing agents are preferably selected from a wide range of chemicals that include, but are not limited to, such reducing agents as ascorbic and erythorbic acids, hydrosulfites, oxalic acid, sodium oxalate, hydroquinones or reducing sugars such as D-glucose, catechol and tannin or tannic acid. For the treatment of potable water, the reducing agent should be non-toxic. A preferred reducing agent is erythorbic acid, ascorbic acid or water soluble salts thereof.

The regenerant compositions and method for regeneration of the present invention are described in detail hereinafter in the Examples. These Examples are presented to describe exemplary embodiments of the invention and are not meant to limit the invention.

### EXAMPLE 1

Counter current regeneration capabilities of sodium chloride and Zeolite 4A were tested in the following manner. The test was performed in an EcoWater Systems LLC model NSC30UD water softener. The regeneration and exhaustion cycles were controlled by using the stock control valve present on the softener. Regeneration chemical (brine introduction for sodium chloride regeneration and zeolite suspension introduction for the Zeolite 4A regeneration) was carried out using the aspirator that came with the softener. Woodbury, Minn. tap water at 16.3 grains per gallon total hardness was used as needed for regeneration, rinse and exhaustion cycles. Purified water from a softener/RO system was used in subsequent analytical work. Exhaustion endpoints were established by using a HACH Model SP-510 Hardness Monitor. Total hardness leakage through each exhaustion cycle was followed with by EDTA titration of grab samples.

A gellular strongly acidic cation resin in the sodium form made by the Purolite Company was the water softening resin utilized. The resin was exhausted with Woodbury, MN city water and then cycled through multiple regeneration/exhaustion cycles at 3 lb/cubic foot sodium chloride, 10 lb/cubic foot sodium chloride, 16 lb/cubic foot sodium chloride, and 32 lb/cubic foot sodium chloride to establish a baseline of performance for comparison followed by regeneration with 4 lb/cubic foot of powdered Zeolite 4A, 8 lb/cubic foot of powdered Zeolite 4A, 12 lb/cubic foot of powdered Zeolite 4A, and 16 lb/cubic foot of powdered Zeolite 4A.

### EXAMPLE 2

The regenerated capacity produced by using Zeolite 4A in a single dose equilibrium rather than in a flow through the resin bed was measured by using an EcoWater Systems LLC model NSC30UD water softener. A gellular strongly acidic cation resin in the sodium form made by the Purolite Company was the water softening resin utilized. The resin in the softener was exhausted using Woodbury, Minn. tap water at 16.3 grains/gallon total hardness and then cycled through multiple regeneration exhaustion cycles. The resin in the softener was dewatered by using compressed air, an aqueous suspension containing sufficient sodium form Zeolite 4A, to produce a dose rate of 16 lb/cubic foot of sodium form Zeolite 4A, was introduced into the dry softener bed, and enough water was added through the control valve to fully immerse the bed and cover it with 1 cm of free water. The bed was then air mixed for 15 minutes, allowed to stand for 60 minutes before the softener control valve was used to carry out a standard slow rinse/fast rinse/back wash.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A non-chloride containing, low TDS regenerant composition for regenerating a strong acid cation exchange resin comprising about 1 to 60 weight percent an inorganic sodium zeolite, and the balance of water.

2. The regenerant composition of claim 1 wherein the inorganic sodium zeolite comprises Type A, P, MAP, or X sodium zeolite, or any combination thereof.

3. The regenerant composition of claim 1 including about 0.0005 to 0.5 weight percent of at least one surfactant.

4. The regenerant composition of claim 3 wherein said at least one surfactant is anionic or non-ionic.

5. The regenerant composition of claim 1 wherein said inorganic sodium zeolite comprises a fine solid powder or pre-made stable aqueous suspension.

6. The regenerant composition of claim 1 including additives to provide protection against development of fouling problems, said additives including citric acid to sequester iron present in the hard water that potentially fouls the cation exchange resin sites; or reducing agents; or a combination thereof.

7. The regenerant composition of claim 6 wherein, for the treatment of potable water, said reducing agents are non-toxic, and include erythorbic acid, ascorbic acid, or water soluble salts thereof.

8. The regenerant composition of claim 7 including ascorbic and erythorbic acids, hydrosulfites, oxalic acid, sodium oxalate, hydroquinones, or reducing sugars.

9. The regenerant composition of claim 8 wherein said reducing agent includes D-glucose, catechol, tannin, or tannic acid.

10. A method for treating a spent strong acid cation exchange resin to regenerate said resin comprising the steps of:
diluting a concentrated suspension of at least one inorganic sodium zeolite; and
combining the balance of water.

11. The method of claim 10 including combining at least one surfactant to form a dilute solution from about 5 to about 60 weight % inorganic sodium zeolite.

12. The method of claim 10 wherein the at least one of said inorganic sodium zeolite comprises:
Type A, P, MAP, or X sodium zeolite.

13. The method of claim 11 wherein said at least one surfactant includes about 0.0005 to 0.5 weight percent of Polysorbate 80.
